(19) United States
(12) Patent Application Publication
(10) Pub. No.: US 2024/0317135 A1
(43) Pub. Date: Sep. 26, 2024

(54) Automated Motor Vehicle and Method for Controlling the Automated Motor Vehicle

(71) Applicant: Bayerische Motoren Werke Aktiengesellschaft, Müenchen (DE)

(72) Inventors: Yannick FORSTER, Muenchen (DE); Frederik NAUJOKS, Muenchen (DE)

(21) Appl. No.: 18/546,053

(22) PCT Filed: Feb. 3, 2022
(86) PCT No.: PCT/EP2022/052560

§ 371 Date: Aug. 10, 2023

(30) Foreign Application Priority Data
Feb. 11, 2021 (DE) 10 2021 103 242.3

(51) Int. Cl. B60Q 9/00; G06T 7/20; G06T 7/70; G06V 20/59

(52) U.S. Cl. CPC B60Q 9/00; G06T 7/20; G06T 7/70; G06V 20/597; G06T 2207/30196; G06T 2207/30268

(57) ABSTRACT

An automated motor vehicle that has a sensor device which continuously determines a viewing direction of a person sitting on a driver's seat, and a control device connected to the sensor device. The control device determines a frequency of a change in the viewing direction on the basis of the viewing direction determined by the sensor device, compares the frequency with a predetermined limit value, and if the frequency is greater than the predetermined limit value, outputs a control signal to an information output device connected to the control device. The information output device outputs a predetermined item of information to the person sitting on the driver's seat after receiving the control signal.

This application is a 371 of International Application No. PCT/EP2022/052560, filed Feb. 3, 2022 which claims priority under 35 U.S.C. § 119 from German Patent Application No. 10 2021 103 242.3, filed Feb. 11, 2021, the entire disclosure of which is herein expressly incorporated by reference.

### BACKGROUND AND SUMMARY OF THE INVENTION

The present invention relates to an automated motor vehicle and to a control method for the automated motor vehicle.

An automated motor vehicle is intended in the present case to mean a motor vehicle which is configured to perform transverse and/or longitudinal guiding of a motor vehicle at least partially in an automated or autonomous fashion.

During (highly) automated driving, a driver does not need to monitor a “vehicle” system continuously.

During automated driving, the driver therefore has the opportunity to deal with matters other than monitoring the “vehicle” system, for example watching a mobile terminal and/or reading a book, which would at least sometimes not be possible or legally allowed during manual driving because of the need to perform a driving task.

A problem, however, is that a lack of confidence on the part of the driver may lead to the driving capability of the automated motor vehicle, in particular the driving assistance systems installed therein, not being fully exploited. In order for the driver to refrain from performing the actual driving task in the manner described above, and engage in a non-driving activity or even go to sleep, this necessary confidence of the driver is required.

The object of the present invention is therefore to provide an automated motor vehicle and a control method for the automated motor vehicle, each of which is configured in order to avoid the disadvantages described above.

This object is achieved according to the invention by the features of the independent claims. Advantageous developments are specified in the dependent claims.

Accordingly, the object is achieved by an automated motor vehicle that comprises a sensor device, which is configured to continuously determine a viewing direction of a person sitting on a driver's seat.

The automated motor vehicle furthermore has a control device, which is connected to the sensor device and is configured to determine a frequency of a change in the viewing direction on the basis of the viewing direction determined by the sensor device, to compare the frequency that has been determined with a predetermined limit value and, if the frequency that has been determined is greater than the predetermined limit value, to output a control signal to an information output device connected to the control device.

The automated motor vehicle furthermore has an information output device, which is configured to output an item of information to the person sitting on the driver's seat after receiving the control signal.

In other words, the confidence which the driver has in the automated motor vehicle is ascertained by tracking eye movements. In the event of continued lack of confidence, that is to say when there are many viewing changes to check the current driving situation, the driver is proactively supplied with at least one item of information by the automated motor vehicle. It is conceivable, in particular, for the driver to be informed of the driving functions of the automated motor vehicle.

The sensor device may be a camera system, which is configured to acquire image data of the person sitting on the driver's seat by means of a camera directed at the driver's seat. The camera may furthermore output these acquired image data to an image data processing device, which is configured to determine the viewing direction of the person sitting on the driver's seat on the basis of the image data received from the camera.

The control device may have an input interface, by means of which it is connected to the camera system and by means of which it receives the information relating to the viewing direction of the person sitting on the driver's seat. From the input interface of the control device, the data may be output to a computer unit, which has an algorithm that is configured to determine a frequency of a change in the viewing direction on the basis of the information relating to the driver's viewing direction, and to compare this frequency that has been determined with a predetermined limit value. The algorithm may furthermore be configured to drive an output interface of the control device, this output interface being connected to the computer unit, so that it outputs a control signal to the information output device when the frequency that has been determined is greater than the predetermined limit value.

The information output device may be configured to output the information auditively, visually and/or haptically.

It is conceivable that for this purpose the information output device comprises a loudspeaker, a display and/or a vibration device, which in particular is installed on a steering wheel and/or on the driver's seat.

The control device may be configured to output the control signal to the information device on the basis of data received from the motor vehicle, which relate to at least one item of information concerning the person sitting on the driver's seat.

The at least one item of information may comprise information concerning a gender and/or a name of the person sitting on the driver's seat.

The control device may be configured to output the control signal to the information output device only if the frequency of the change in the viewing direction is greater than the predetermined limit value for longer than a predetermined length of time or for longer than a predetermined period of time.

A control method for an automated motor vehicle is furthermore provided.

That which has been described above relating to the motor vehicle also applies correspondingly for the method, and vice versa.

The method comprises a step of continuously determining a viewing direction of a person sitting on a driver's seat of the motor vehicle.

The method also comprises a step of determining a frequency of a change in the viewing direction and a step of comparing the frequency that has been determined with a predetermined limit value.

The method furthermore comprises a step of outputting a control signal to an information output device if the comparison reveals that the frequency is greater than the predetermined limit value.

The method also comprises a step of outputting an item of information to the person sitting on the driver's seat after or in response to the reception of the control signal.

It is conceivable for the item of information to be output auditively, visually and/or haptically.

The control signal may be output to the information output device on the basis of data received from the motor vehicle, the data comprising at least one item of information concerning the person sitting on the driver's seat.

It is conceivable for the at least one item of information to comprise information concerning a gender and/or a name of the person sitting on the driver's seat.

It is furthermore conceivable for the control signal to be output to the information output device only, or exclusively, if the frequency of the change in the viewing direction is greater than the predetermined limit value for longer than a predetermined length of time.

That which has been described above may, in other words, be summarized as follows: a current level of confidence may be ascertained by tracking eye movements (so-called “monitoring frequenzy”). The system, or the motor vehicle, therefore has the opportunity to identify when the driver's confidence in the system, particularly in the case of automated driving, is low since many viewing changes are carried out in order to check the situation. If this behavior persists even after prolonged use of the automated motor vehicle, that is to say confidence is not established and the driver is not using the system as they actually could, the possibility of performing non-driving activities is proactively pointed out. One possibility in this case is the use by the system of so-called “anthropomorphic cues” (for example voice, name, gender, direct address).

In particular by directly addressing the driver, the driver's confidence may be increased to a suitable level and the acceptance of the driving system, particularly a highly or fully automated driving system, may thereby be increased.

The above-described at least one item of information concerning the person sitting on the driver's seat may also be referred to as personalized information. In particular, it is conceivable that the person sitting on the driver's seat is identified in order to determine this at least one item of information. The identification may, for example, be carried out by comparing characteristics of the person sitting on the driver's seat with characteristics saved in a database of the motor vehicle. The database may be stored in the motor vehicle itself, although it is also conceivable for the database to be stored additionally or alternatively outside the motor vehicle, for example in a cloud.

One possibility for identifying the driver may be face recognition, in which case this may comprise an analysis of the appearance of visible features in the region of the front of the driver's head, defined by a geometrical arrangement and textural characteristics of the surface, for characteristic determination. An additional or alternative possibility for identifying the driver may be fingerprint recognition, in which case this may comprise an analysis of a lower side of a fingertip, for example by means of a sensor on the steering wheel, for characteristic determination.

A further additional or alternative possibility for identifying the driver may be interrogation of information stored on a vehicle key, for example the driver's name.

As already described above, the motor vehicle is configured to drive in an automated, in particular autonomous fashion. The autonomous driving, or automated driving, may be carried out so that the progress of the motor vehicle takes place (substantially) autonomously. The motor vehicle may be a vehicle of autonomy level 1, that is to say it has particular driving assistance systems which help the driver to operate the vehicle, for example adaptive cruise control (ACC). The motor vehicle may be a vehicle of autonomy level 2, that is to say it is semiautomated so that functions such as automatic parking, keeping in lane or transverse guiding, general longitudinal guiding, acceleration and/or braking are undertaken by driving assistance systems. The motor vehicle may be a vehicle of autonomy level 3, that is to say conditionally automated so that the driver does not constantly need to monitor the vehicle system. The vehicle independently carries out functions such as operating the turn signals, changing lanes and/or keeping in lane. The driver can turn to other things but if necessary is prompted by the system to take control of the motor vehicle guidance within an advance warning time. The motor vehicle may be a vehicle of autonomy level 4, that is to say so highly automated that the guiding of the vehicle is permanently undertaken by the vehicle system. If the driving tasks are no longer be managed by the system, the driver may be prompted to take control of the guiding. The motor vehicle may be a vehicle of autonomy level 5, that is to say so fully automated that the driver is not needed to perform the driving task. Besides the destination that is defined and the starting of the system, no human intervention is needed. The vehicle can then function without a steering wheel and pedals.

It is conceivable in particular for the personalized information described above to be output with a natural voice. This natural voice may imitate a human voice, that is to say it may imitate the sound generated by person's vocal chords and modulated in the mouth, the pharynx and the nasal cavities. Generation of the natural voice may, for example, comprise concatenation of previously recorded speech segments for personalized information output.

By the technology of concatenating previously recorded speech segments for personalized information output, it is substantially possible to avoid synthesis of the speech signal, that is to say analysis of human speech in respect of phonemes as well as intonation, and a natural voice, that is to say one which is substantially similar to the human voice, may thus be generated.

Embodiments of the present invention will be described below with reference to FIGS. 1 and 2.

### BRIEF DESCRIPTION OF THE DRAWINGS

FIG. 1 schematically shows an automated motor vehicle, and

FIG. 2 shows a flowchart of a control method for the automated motor vehicle of FIG. 1.

### DETAILED DESCRIPTION OF THE DRAWINGS

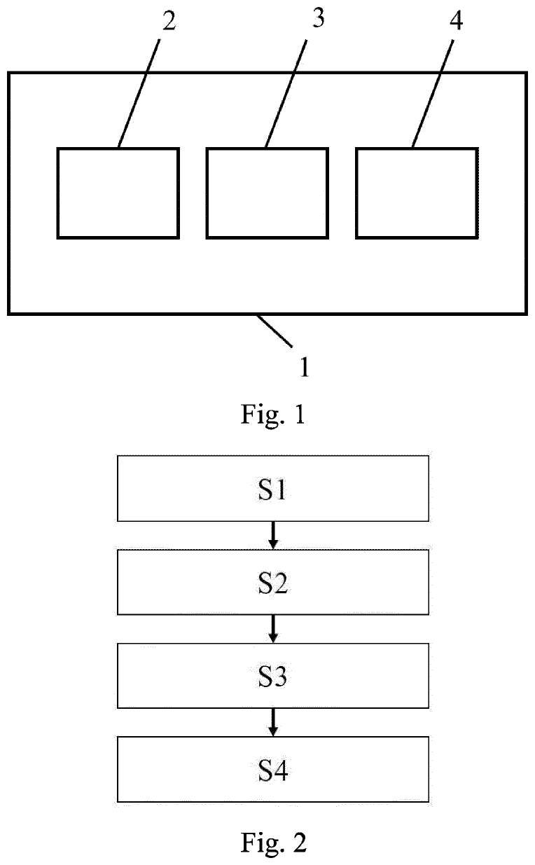

The motor vehicle 1 indicated only schematically in FIG. 1 comprises a sensor device 2, a control device 3 connected to the sensor device 2, and an information output device 4 connected to the control device 3.

The sensor device 2 is configured to continuously determine a viewing direction of a person sitting on a driver's seat. For this purpose, the sensor device 2 in the present case comprises a camera (not represented) which is arranged in a motor vehicle interior of the motor vehicle 1.

By means of an object recognition algorithm, the camera, which is configured so that it can record or acquire image data of the person sitting on the driver's seat, determines at least one position of the eyes of the person sitting on the driver's seat so as to determine the respective viewing direction of this person.

The control device 3 is connected on the input side to the sensor device 2 and on the output side to the information output device 4.

The information output device 4 is connected on the input side to the control device 3 and comprises a plurality of output devices arranged in the motor vehicle interior, which in the present case comprise a display, which is arranged in a field of view of the person sitting on the driver's seat, and a loudspeaker system, which is configured to output auditive information audible to the person sitting on the driver's seat in the motor vehicle interior.

The automated motor vehicle 1 is configured to carry out the method, or control method, described below with reference to FIG. 2.

As may be seen in FIG. 2, the control method for the automated motor vehicle 1 essentially comprises four steps S1-S4.

In a first step S1 of the method, in the manner described above, the sensor device 2 records image data concerning the person sitting on the driver's seat and, on the basis of the recorded image data, determines a viewing direction of the person sitting on the driver's seat continuously, that is to say at regular intervals and/or constantly.

The sensor device 2 furthermore outputs the viewing directions thus determined to the control device 3 in the first step S1 of the method.

In a second step S2 of the method, the control device 3 initially receives the viewing directions determined by the sensor device 2, in order subsequently to determine a frequency of a change in the viewing direction on the basis of the received viewing directions.

In a third step S3 of the method, the control device 3 subsequently compares the frequency thus determined with a predetermined limit value. If it is found by means of this comparison by the control device 3 in the third step S3 of the method that the previously determined frequency of the change in the viewing direction is greater than the predetermined limit value for a predetermined length of time, the control device 3 outputs a control signal to the information output device 4.

In a fourth step S4 of the method, the information output device 4 connected on the input side to the control device 3 receives the control signal output by the control device 3 in the third step S3.

After receiving the control signal, in the fourth step S4, the information output device 4 outputs an item of information to the driver, or the person sitting on the driver's seat. For this purpose, the information output device 4 uses the display described above, in particular to output visual information, and additionally or alternatively the loudspeaker system described above, in order to output auditive information to the person sitting on the driver's seat.

It is furthermore conceivable that the sensor device 2 outputs not only or exclusively an item of information concerning the viewing direction of the person sitting on the driver's seat to the control device 3 in the above-described step S1 of the method, but also the respective image data acquired or recorded from the person, which subsequently allow the control device 3 to identify the person sitting on the driver's seat in the second step S2 of the method by means of face recognition and a database comparison.

It is furthermore conceivable that, on the basis thereof together with the control signal which is output by the control device 3 in the third step S3 to the information output device 4, the control device 3 also sends personal data of the person sitting on the driver's seat. These personal data may for example comprise a gender and/or a name of the person sitting on the driver's seat. This information may be stored in the above-described database for the person in question.

The information output device 4, which receives the control signal in the fourth step S4 of the method in the manner described above, may thereupon carry out personalized information output to the person sitting on the driver's seat. It is also conceivable that the information output device 4 outputs the information differently as a function of a level of automation of the motor vehicle 1.

Specifically, this may mean that the information output device 4 outputs the following information auditively and/or visually to the person sitting on the driver's seat in the fourth step S4 in the case of a motor vehicle 1 of automation level 3: “Hello [spaceholder: name of person], don't worry about using the personal copilot, feel free to check your emails, I'll let you know in good time when you need to do the driving”.

The same is conceivable for a motor vehicle of automation level 4, in which case an exemplary item of information may be auditively and/or visually output as follows by the information output device 4 in the fourth step S4 of the method: “Hello [spaceholder: name of person], don't worry about using the LA system, feel free to check your emails or have a nap, I'll just stop the car safely when we're there.”

### LIST OF REFERENCES

1 automated motor vehicle

2 sensor device

3 control device

4 information output device

S1-S4 steps of the method

1-10. (canceled)

11. An automated motor vehicle, comprising:
a sensor device configured to continuously determine a viewing direction of a person sitting on a driver's seat; and
a control device connected to the sensor device and configured to:
determine a frequency of a change in the viewing direction on the basis of the viewing direction determined by the sensor device,
compare the frequency with a predetermined limit value, and
if the frequency is greater than the predetermined limit value, to output a control signal to an information output device connected to the control device,
wherein the information output device is configured to output a predetermined item of information to the person sitting on the driver's seat after receiving the control signal.

12. The automated motor vehicle of claim 11, wherein the information output device is configured to output the information auditively, visually and/or haptically.

13. The automated motor vehicle of claim 11, wherein the control device is configured to output the control signal to the information output device on the basis of data received from the motor vehicle, which relate to at least one item of information concerning the person sitting on the driver's seat.

14. The automated motor vehicle of claim 13, wherein the at least one item of information comprises information concerning a gender and/or a name of the person sitting on the driver's seat.

15. The automated motor vehicle of claim 11, wherein control device outputs the control signal to the information output device only if the frequency of the change in the viewing direction is greater than the predetermined limit value for longer than a predetermined length of time.

16. A control method for automated motor vehicle, comprising:
continuously determining a viewing direction of a person sitting on a driver's seat;
determining a frequency of a change in the viewing direction;
comparing the frequency with a predetermined limit value; and
outputting a predetermined item of information to the person sitting on the driver's seat if the frequency that has been determined is greater than the predetermined limit value.

17. The control method of claim 16, wherein the item of information is output auditively, visually and/or haptically.

18. The control method of claim 16, wherein data which comprise at least one item of information concerning the person sitting on the driver's seat are received and taken into account for the output of the item of information.

19. The control method of claim 18, wherein the at least one item of information comprises information concerning a gender and/or a name of the person sitting on the driver's seat.

20. The control method of claim 16, wherein the item of information concerning the person sitting on the driver's seat is output only if the frequency of the change in the viewing direction is greater than the predetermined limit value for longer than a predetermined length of time.
